(19) United States
(12) Patent Application Publication
(10) Pub. No.: US 2025/0150709 A1
(43) Pub. Date: May 8, 2025

(54) IMAGING CONTROL DEVICE, IMAGING DEVICE, AND PROGRAM

(71) Applicant: NIKON CORPORATION, Tokyo (JP)

(72) Inventors: Hidehisa TAKASAKI, Shanghai (CN); Hiroaki YAMAMURA, Kawasaki-shi (JP)

(73) Assignee: NIKON CORPORATION, Tokyo (JP)

(21) Appl. No.: 18/704,673

(22) PCT Filed: Oct. 17, 2022
(86) PCT No.: PCT/JP2022/038571

§ 371 Date: Jan. 9, 2025

(30) Foreign Application Priority Data
Oct. 25, 2021 (JP) 2021-173804

(51) Int. Cl. H04N 23/67; H04N 23/611; H04N 23/63; H04N 23/69

(52) U.S. Cl. CPC H04N 23/675; H04N 23/611; H04N 23/631; H04N 23/69

(57) ABSTRACT

An imaging control device includes: a position setting unit configured to set a first position indicating a position at which tracking of a subject starts in an imaging range in which the subject is imaged; and a tracking control unit configured to track the subject on the basis of a result of detection of the subject overlapping the first position set by the position setting unit.

### TECHNICAL FIELD

The present invention relates to an imaging control device, an imaging device, and a program.

Priority is claimed on Japanese Patent Application No. 2021-173804, filed Oct. 25, 2021, the content of which is incorporated herein by reference.

### BACKGROUND ART

In the related art, an imaging device that starts tracking of a subject with detection of the subject as a trigger using an autofocus function of the imaging device is known (for example, see Patent Document 1).

### CITATION LIST

### Patent Document

Patent Document 1: Japanese Unexamined Patent Application, First Publication No. H11-215422

### SUMMARY OF INVENTION

According to an aspect of the present disclosure, there is provided an imaging control device including: a position setting unit configured to set a first position indicating a position at which tracking of a subject starts in an imaging range in which the subject is imaged; and a tracking control unit configured to track the subject on the basis of a result of detection of the subject overlapping the first position set by the position setting unit.

According to another aspect of the present disclosure, there is provided an imaging device including the imaging control device.

According to another aspect of the present disclosure, there is provided a program causing a computer used in an imaging control device to serve as: a position setting unit configured to set a first position indicating a position at which tracking of a subject starts in an imaging range in which the subject is imaged; and a tracking control unit configured to track the subject on the basis of a result of detection of the subject overlapping the first position set by the position setting unit.

### BRIEF DESCRIPTION OF DRAWINGS

FIG. 1 is a block diagram schematically illustrating an example of a configuration of an imaging device 1 according to a first embodiment.

FIG. 2A is a diagram illustrating an example of tracking and imaging of a subject according to the first embodiment and illustrating a state in which tracking is started.

FIG. 2B is a diagram illustrating an example of tracking and imaging of a subject according to the first embodiment and illustrating a state in which imaging is started.

FIG. 2C is a diagram illustrating an example of tracking and imaging of a subject according to the first embodiment and illustrating a state in which tracking and imaging end.

FIG. 3A is a diagram illustrating an example of an image in an imaging range of an imaging device 1.

FIG. 3B is a diagram illustrating an example of an image in an imaging range of the imaging device 1.

FIG. 3C is a diagram illustrating an example of an image in an imaging range of the imaging device 1.

FIG. 3D is a diagram illustrating an example of an image in an imaging range of the imaging device 1.

FIG. 3E is a diagram illustrating an example of an image in an imaging range of the imaging device 1.

FIG. 3F is a diagram illustrating an example of an image in an imaging range of the imaging device 1.

FIG. 3G is a diagram illustrating an example of an image in an imaging range of the imaging device 1.

FIG. 4 is a diagram illustrating an example of a functional configuration of the imaging device 1.

FIG. 5 is a flowchart illustrating an example of a position setting process that is performed by the imaging device 1.

FIG. 6 is a flowchart illustrating an example of a tracking and imaging process according to the first embodiment.

FIG. 7 is a flowchart illustrating an example of a tracking and imaging process according to the first embodiment.

FIG. 8A is a diagram illustrating an example of an image in an imaging range of an imaging device 1 according to a second embodiment and illustrating an image before a subject reaches a tracking/imaging start position.

FIG. 8B is a diagram illustrating an example of an image in an imaging range of the imaging device 1 according to the second embodiment and illustrating an image when a subject reaching a tracking/imaging start position is imaged.

FIG. 9 is a flowchart illustrating an example of a tracking and imaging process according to the second embodiment.

FIG. 10 is a diagram illustrating an example of a screen when settings of positions are received from a user by an imaging device 1 according to a third embodiment.

FIG. 11 is a flowchart illustrating an example of a tracking and imaging process according to the third embodiment.

### DESCRIPTION OF EMBODIMENTS

### Embodiments

Hereinafter, first to third embodiments of the present invention will be described with reference to the accompanying drawings.

### (Configuration of Imaging Device 1)

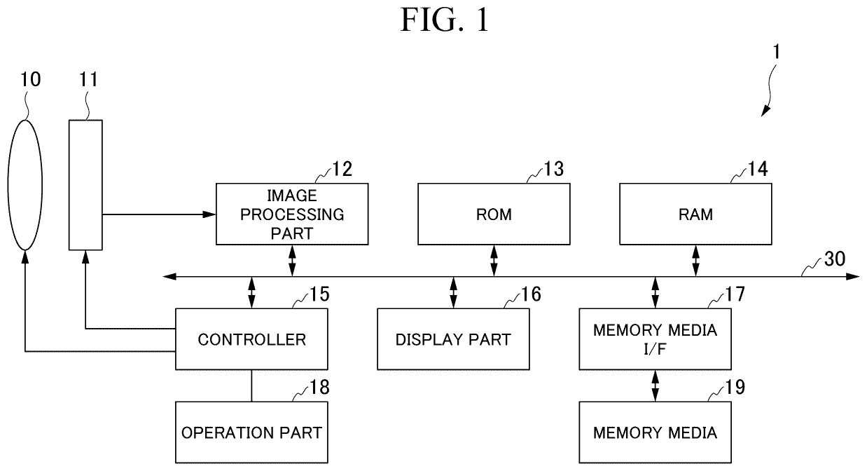

FIG. 1 is a block diagram schematically illustrating an example of a configuration of an imaging device 1 according to a first embodiment. In FIG. 1, the imaging device 1 includes a lens 10, an imaging unit 11, an image processing unit 12, a read only memory (ROM) 13, a random access memory (RAM) 14, a control unit 15, a display unit 16, a storage medium I/F (a storage medium interface) 17, an operation unit 18, a storage medium 19, and a bus 30. The image processing unit 12, the ROM 13, the RAM 14, the control unit 15, the display unit 16, and the storage medium I/F 17 are connected to each other via the bus 30. The operation unit 18 is connected to the control unit 15.

The lens 10 includes a group of a plurality of lenses such as a focusing lens and a zoom lens. The lens 10 includes one or more lenses. The lens 10 is driven by a lens drive device (not illustrated) on the basis of control of the control unit 15.

The imaging unit 11 captures a subject image and generates pixel data (image data) of a captured image. Specifically, the imaging unit 11 includes a plurality of pixels arranged in rows and columns and generates an analog pixel signal of an image by photoelectrically converting a subject image formed on an imaging surface to a subject image. The analog pixel signal generated by the imaging unit 11 is adjusted and converted in an analog/digital (A/D) conversion manner by an analog front end circuit which is not illustrated. A digital pixel signal subjected to the conversion is output as image data to the image processing unit 12.

The image processing unit 12 stores image data in the RAM 14. The image processing unit 12 performs various types of image processes such as white balancing. The image processing unit 12 causes the display unit 16 to display predetermined image data.

The ROM 13 stores a control program for controlling the imaging device 1. The control program includes a program associated with tracking of a subject or imaging of a subject which will be described later.

The RAM 14 stores image data captured by the imaging unit 11 or various types of setting information associated with tracking of a subject or imaging of a subject.

The control unit 15 is an example of an imaging control device. The control unit 15 includes, for example, a processor such as a central processing unit (CPU) and comprehensively controls the imaging device 1. The control unit 15 controls the constituent units of the imaging device 1 by executing an imaging control program stored in advance in the ROM 13. For example, when an imaging instruction is received via the operation unit 18, the control unit 15 stores image data acquired via the imaging unit 11 as a captured image in the storage medium 19.

The control unit 15 performs autofocus control or automatic exposure control. Specifically, the control unit 15 performs a distance measuring process of a subject and controls a focusing lens of the lens 10 on the basis of the result of the distance measuring process. The autofocus includes autofocus of a single point and autofocus of multiple points. The control unit 15 also performs changing of an exposure time, control of an iris mechanism (not illustrated), or the like.

The display unit 16 is a touch panel type display. For example, the display unit 16 is a liquid crystal play. The display unit 16 displays an image generated by the image processing unit 12 in accordance with an instruction from the control unit 15.

The display unit 16 displays, for example, image data captured by the imaging unit 11 or an operation screen. The display unit 16 is also used as the operation unit 18 for receiving various operations from a user.

The operation unit 18 may be, for example, a release button, a cross key, a command dial, a touch panel, or other operation keys and inputs an input signal to the control unit 15 according to details of a user's operation. The operation unit 18 inputs an imaging instruction to the control unit 15, for example, by allowing a user to fully push the release button.

The storage medium I/F 17 is connected to a removable storage medium 19 such as a card memory and performs recording, reading, or deleting image data with respect to the storage medium 19.

The storage medium 19 is a storage unit that is detachably connected to the imaging device 1 and stores (records), for example, image data processed by the image processing unit 12. The storage medium 19 is, for example, an SD card or a micro SD card.

The bus 30 connects the image processing unit 12, the ROM 13, the RAM 14, the control unit 15, the display unit 16, and the storage medium I/F 17 and transmits image data, control signals, or the like output from the constituent units.

### (Tracking and Imaging of Subject According to First Embodiment)

The imaging device 1 can be used to image an athlete in various sports events such as a gymnastics event, a track and field event, and a skiing event. For example, the imaging device 1 can start tracking of a subject with detection of a subject such as an athlete as a trigger. The imaging device 1 has a subject detecting function and an autofocus function. The subject detecting function is a function of detecting where in a frame a subject is located. The autofocus function is a function of focusing on a detected subject. The autofocus function may include the subject detecting function. Tracking of a subject means that a detected subject is tracked continuously. The tracking of a subject also means that a subject is continuously tracked and focusing on the subject is maintained. Even when a subject moves and the position of the subject in a frame changes, the imaging device 1 can continuously track the subject and maintain focus on the subject through the subject tracking function. The subject is not limited to a person such as an athlete in the aforementioned various sports events and may be, for example, an animal.

When a person or an object other than an athlete in an imaging range is tracked as a subject, the athlete originally intended to be imaged cannot be tracked as a subject. Therefore, the imaging device 1 according to this embodiment enables a subject desired by a user to be tracked. Control of tracking of a subject and imaging of a subject according to the first embodiment will be described below with reference to a vaulting competition in a gymnastics event as an example.

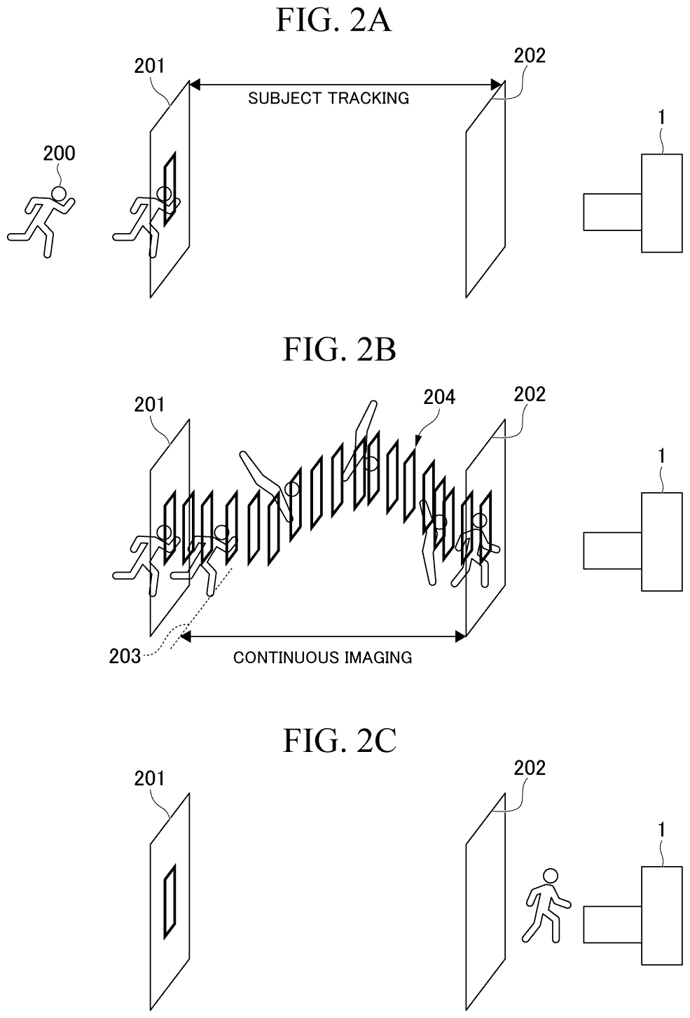

FIGS. 2A to 2C are diagrams illustrating an example of tracking and imaging of a subject according to the first embodiment. FIG. 2A is a diagram illustrating a state in which tracking is started. FIG. 2B is a diagram illustrating a state in which imaging is started. FIG. 2C is a diagram illustrating a state in which tracking and imaging are ended. In FIGS. 2A and to 2C, the imaging device 1 is disposed in an imaging zone near a landing mat of a gymnastics event and can track a subject (athlete) running from an infinite side (a start point) to a close side. Specifically, the imaging device 1 can automatically track and image an athlete who moves from a rear side to a front side in a depth direction of the imaging range in an automatic imaging mode.

As illustrated in FIG. 2A, in the imaging device 1, a tracking start position 201 is set in a depth direction of an imaging range from the imaging device 1. In the imaging device 1, an end position 202 is set on a side closer in the depth direction than the tracking start position 201. As illustrated in FIG. 2B, in the imaging device 1, an imaging start position 203 is set between the tracking start position 201 and the end position 202.

As illustrated in FIG. 2A, it is assumed that a subject 200 runs from a rear side to a front side in the depth direction of the imaging device 1. The imaging device 1 starts tracking of the subject 200 when the subject 200 reaches the tracking start position 201. When the subject 200 reaches the imaging start position 203 as illustrated in FIG. 2B, the imaging device 1 starts imaging of the subject 200 (continuous imaging). In this example, when the subject 200 moves from the tracking start position 201 to the front side, the imaging device 1 moves a focus position to the nearer side using the autofocus function with the movement of the subject 200. When the subject 200 reaches the imaging start position 203, the imaging device 1 focuses on the subject 200 using the autofocus function and maintains focusing on the subject 200 using the autofocus function even while the continuous imaging is being performed. When the subject 200 reaches the end position 202 as illustrated in FIG. 2C, the imaging device 1 ends the continuous imaging and tracking of the subject 200 and returns the focus position to the tracking start position 201. Objects 204 indicate that the imaging device 1 is tracking or imaging the subject 200.

### (Image in Imaging Range)

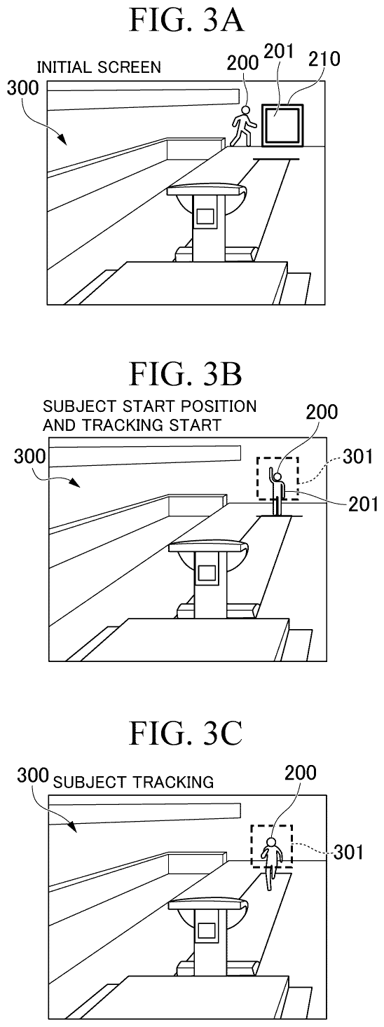

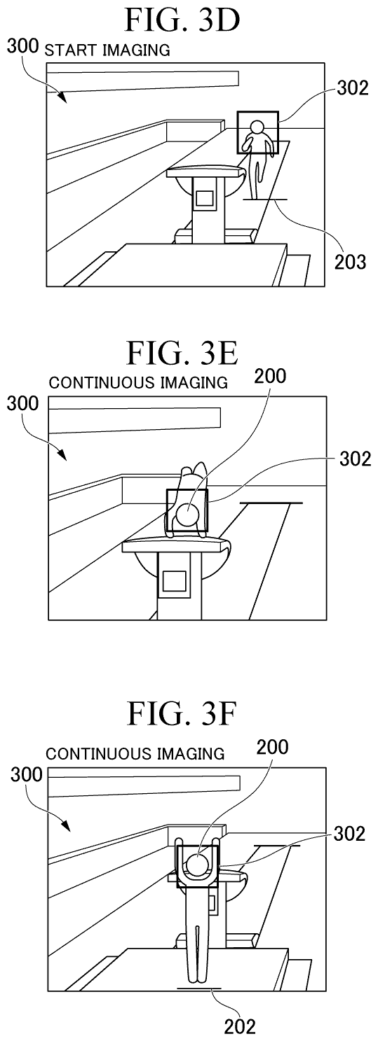

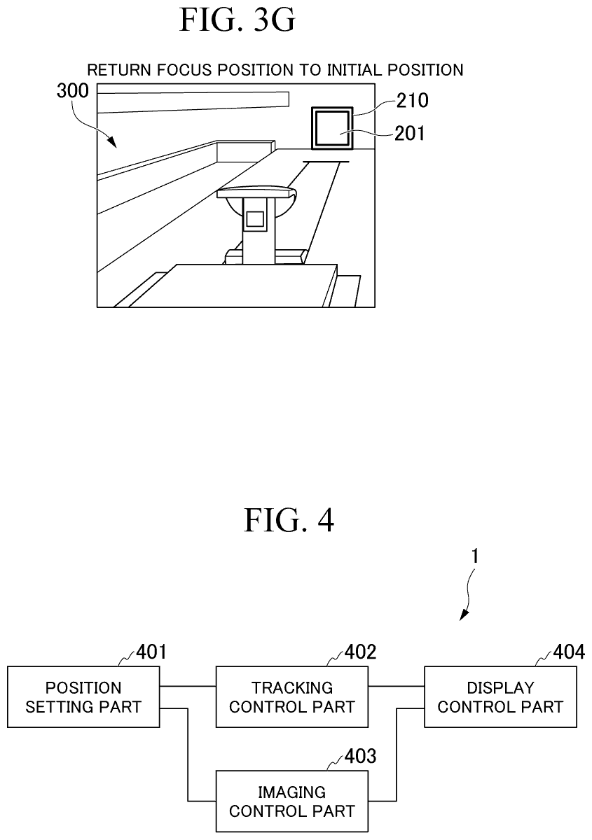

FIGS. 3A to 3G are diagrams illustrating examples of an image in the imaging range of the imaging device 1. The images illustrated in FIGS. 3A to 3G are images which are displayed on the display unit 16 or a viewfinder. For example, the images of FIGS. 3A to 3G are displayed sequentially in a time series on the display unit 16 or the viewfinder. That is, the image of FIG. 3B is displayed subsequently to the image of FIG. 3A. The image of FIG. 3C is displayed subsequently to the image of FIG. 3B. The image of FIG. 3D is displayed subsequently to the image of FIG. 3C. The image of FIG. 3E is displayed subsequently to the image of FIG. 3D. The image of FIG. 3F is displayed subsequently to the image of FIG. 3E. The image of FIG. 3G is displayed subsequently to the image of FIG. 3F. Each of the images of FIGS. 3A to 3G is a representative image out of a plurality of images, and another image which is not illustrated may be captured between the drawings (for example, between FIG. 3A and FIG. 3B). First, in FIG. 3A, a tracking start position image 210 (for example, double frames) indicating a tracking start point (a tracking start position 201) is set as a first position. Since a subject 200 does not overlap the tracking start position 201, the imaging device 1 does not perform tracking or imaging of the subject 200.

Then, in the imaging range 300 illustrated in FIG. 3B, the subject 200 is located at the tracking start position 201. The imaging device 1 starts tracking of the subject 200 when the subject 200 overlaps the tracking start position 201. The imaging device 1 displays a tracking point image 301 (for example, a dotted frame) indicating a focus point to overlap the subject 200 when performing tracking of the subject 200. Then, after having started tracking of the subject 200, the imaging device 1 continues to track the subject 200 as illustrated in FIG. 3C.

Then, when the subject 200 reaches an imaging start position 203 as illustrated in FIG. 3D, the imaging device 1 starts continuous imaging. When imaging of the subject 200 is performed, the imaging device 1 displays an imaging point image 302 (for example, a solid frame) indicating an imaging point. When an athlete (the subject 200) puts hands on the vaulting horse after having started imaging as illustrated in FIG. 3E, the imaging device 1 continues to perform continuous imaging.

When the athlete (the subject 200) reaches a landing point as illustrated in FIG. 3F, the imaging device 1 also continues to perform continuous imaging. Then, when the subject 200 reaches an end position 202 set closer to the imaging device 1 than the landing point, the imaging device 1 returns the tracking start point (the tracking start position image 210) to the tracking start position 201 and prepares for tracking an athlete (a subject 200) who will compete next as illustrated in FIG. 3G.

### (Functional Configuration of Imaging Device 1)

A functional configuration of the imaging device 1 will be described below with reference to FIG. 4.

FIG. 4 is a diagram illustrating an example of the functional configuration of the imaging device 1. As illustrated in FIG. 4, the imaging device 1 includes a position setting unit 401, a tracking control unit 402, an imaging control unit 403, and a display control unit 404. The position setting unit 401, the tracking control unit 402, and the imaging control unit 403 are realized by the control unit 15 (CPU). That is, by causing the control unit 15 to execute an imaging control program stored in the ROM 13, the functions of the units 401 to 403 are realized. The display control unit 404 is realized by the control unit 15 and the image processing unit 12. That is, by causing the control unit 15 to execute an imaging control program and to transmit a predetermined instruction to the image processing unit 12, the function of the display control unit 404 is realized.

The units 401 to 404 are not limited to being provided in the imaging device 1 and may be provided in an external device (an imaging control device). That is, for example, the imaging device 1 may perform tracking or imaging of a subject 200 on the basis of an instruction from the external device. In this embodiment, the imaging device 1 is, for example, a camera, but is not limited thereto. The imaging device 1 may be a video camera, a smartphone, a tablet device, or a mobile phone.

### (Setting of Tracking Start Position 201)

The position setting unit 401 sets a tracking start position 201 indicating a position at which tracking of the subject 200 is started in the imaging range 300 in which the subject 200 is imaged. The tracking start position 201 is an example of the first position. The tracking start position 201 set by the position setting unit 401 is stored, for example, in the RAM 14. The position setting unit 401 sets the tracking start position 201 on the basis of a user's operation. Instead of setting the tracking start position 201 on the basis of a user's operation, the imaging device 1 may automatically recognize a position (for example, a start line) at which the subject 200 starts the competition and set the position as the tracking start position 201.

In an automatic imaging mode of the imaging device 1, the tracking control unit 402 tracks the subject 200 on the basis of a result of detection of the subject 200 overlapping the tracking start position 201 set by the position setting unit 401. The result of detection of the subject 200 includes simply detecting that the subject 200 is present in the imaging range 300. Tracking of the subject 200 includes an operation of continuing to track the subject 200 without focusing on the subject 200. In this case, when the subject 200 reaches the imaging start position 203, the tracking control unit 402 performs the operation of focusing on the subject 200 and maintaining the in-focus state. Here, in the first embodiment, it is assumed that tracking of the subject 200 is a tracking operation of focusing on the subject 200 and maintaining the in-focus state. Specifically, tracking is tracking the subject 200 while automatically switching a ranging point (an autofocus frame) for the subject 200.

A direction in which the tracking control unit 402 tracks the subject 200 is the depth direction of the imaging range 300. Specifically, the direction in which the subject 200 is tracked is, for example, a direction from a rear side to a front side in the depth direction of the imaging range 300. The direction in which the subject 200 is tracked is not limited thereto and may be a direction from the front side to the rear side in the depth direction of the imaging range 300. The direction in which the subject 200 is tracked may be set to a vertical direction of the imaging range 300 or may be set to a horizontal direction of the imaging range 300. The direction in which the subject 200 is tracked is not limited to one direction and may be a combination of a plurality of directions.

### (Result of Detection of Subject 200)

The result of detection of the subject 200 includes, for example, at least one of a face, a size, a motion, and a orientation of the subject 200. Regarding the face of the subject 200, a person recognized using a face recognizing function of the imaging device 1 can be acquired as the result of detection. Regarding the size of the subject 200, a person with a predetermined size (for example, 140 cm to 190 cm) can be acquired as the result of detection of the subject 200. Regarding the motion of the subject 200, a person adopting a predetermined motion (for example, a running motion, a running direction, or a running speed) can be acquired as the result of detection of the subject 200. Regarding the orientation of the subject 200, a person with a predetermined orientation (for example, an orientation in which the person faces the imaging device 1 or an orientation in which the person raises a hand) can be acquired as the result of detection of the subject. In an event or the like, a number attached to a body of the subject 200 which is an athlete may be used as the result of detection.

The tracking control unit 402 tracks the subject 200 on the basis of at least one of the faces, the size, the motion, and the orientation as the result of detection of the subject 200 overlapping the tracking start position 201. The face, the size, the motion, and the orientation are set as conditions for tracking start. Which of the face, the size, the motion, and the orientation is used as the conditions for tracking start may be set to be invariable in advance or may be set to be variable according to a user's selection.

The conditions for tracking start may be set in advance for each sports event (such as the orientation of a subject 200) and the subject 200 satisfying the set conditions may be automatically detected by the tracking control unit when a user selects a sports event. For example, when an orientation in which a subject 200 runs is set in advance in an event, a subject 200 matching the orientation can be automatically detected.

### (Specific Example of Settings of Tracking Start Position 201)

The tracking start position 201 is set on the basis of focus information of a subject 200 and a predetermined imaging area in the imaging range 300 (hereinafter referred to as a “predetermined area”). The focus information is information corresponding to a distance to the tracking start position 201 when a focus is put on the tracking start position 201. For example, when the tracking start position 201 is set at a position of 40 m in front, the focus information is information indicating an amount of control of the lens 10 corresponding to the distance to the tracking start position 201 when a focus is put on the position of 40 m in front. For example, the focus information may be in-focus information or depth information when a focus is put on the position of 40 m in front.

In setting the tracking start position 201, a user disposes a person or an object at a position at which tracking is started (for example, a position of 40 m in front). The imaging device 1 focuses on the person or the object in a position setting mode. Accordingly, the position setting unit 401 sets the focus information of the tracking start position 201.

The position setting unit 401 sets a predetermined area in the imaging range 300. The predetermined area can be an arbitrary area in the vertical direction and the horizontal direction in the imaging range 300. For example, the position setting unit 401 sets an arbitrary range designed by a user in the imaging range 300 as the predetermined area. This designation of the range is performed, for example, by a user's touch of the display unit 16 or a user's operation of the operation unit 18. In this embodiment, the predetermined area indicating the tracking start position 201 is an area included in the tracking start position image 210 illustrated in FIG. 3A in the imaging range 300. By setting the focus information of the subject 200 and the predetermined area in the imaging range 300 as the tracking start position 201, an object or a person satisfying both conditions can be detected as the subject 200. Accordingly, for example, when an umpire of the sports event overlaps the predetermined area, but the umpire is out of focus, the umpire is not detected as the subject 200 and thus it is possible to prevent the umpire from being erroneously tracked.

The tracking start position 201 may be set on the basis of at least one of the focus information of the subject 200 and the predetermined area in the imaging range 300. That is, the tracking start position 201 may be set based on only the focus information of the subject 200 or may be set on the basis of only the predetermined area in the imaging range 300. When the tracking start position 201 is set based on the predetermined area in the imaging range 300, tracking is started in the case in which the subject 200 overlaps the predetermined area. This case includes a case in which the subject 200 partially overlaps the predetermined area as well as a case in which the subject 200 fully overlaps the predetermined area. When the tracking start position 201 is set on the basis of the focus information, tracking of the subject 200 is started, for example, when a focus is put on the subject 200 at a position of 40 m in front. Tracking of the subject 200 may be started when the subject 200 overlaps an area defocused in a predetermined range before or after in the depth direction at the in-focus position.

### (Setting of Imaging Start Position 203)

The position setting unit 401 sets the imaging start position 203 indicating a position at which imaging of the subject 200 is started. The imaging start position 203 is an example of a second position. In the automatic imaging mode of the imaging device 1, the imaging control unit 403 starts imaging of a subject 200 overlapping the imaging start position 203 after having started tracking of the subject 200. Image data acquired from the imaging unit 11 through the imaging is stored as a captured image in the storage medium 19 or is transmitted to an external storage device using a communication function (not illustrated). The imaging control unit 403 performs continuous imaging (frame imaging) of image data, for example, imaging of 30 frames per second.

Similarly to the setting of the tracking start position 201, setting of the imaging start position 203 can be performed based on at least one of the focus information data pieces of the subject 200 and the predetermined area in the imaging range 300. Specifically, in setting the imaging start position 203, a user disposes a person or an object at a position at which imaging is started (for example, a position of 20 m in front). The imaging device 1 focuses on and images the person or the object in the position setting mode. Accordingly, the position setting unit 401 sets the focus information at the imaging start position 203.

The position setting unit 401 sets a predetermined area designated by a user in the imaging range 300 at the imaging start position 203. In this embodiment, the predetermined area indicating the imaging start position 203 is substantially the same area as the upper-right area of the screen indicated by the imaging point image 302 in FIG. 3D in the imaging range 300.

The tracking start position 201 and the imaging start position 203 are positions which are separated from each other in the depth direction of the imaging range 300. When a captured image of the subject 200 moving from the rear side to the front side of the imaging range 300 is acquired as in this embodiment, the imaging start position 203 is set to be a position nearer than the tracking start position 201. Here, when a captured image of a subject 200 moving from the front side to the rear side in the imaging range 300 is acquired, the imaging start position 203 can be set to be a position deeper than the tracking start position 201.

### (End of Tracking and Imaging of Subject 200)

The tracking control unit 402 ends tracking of the subject 200 when a predetermined ending condition is satisfied. Similarly, when a predetermined ending condition is satisfied, the imaging control unit 403 ends imaging of the subject. The predetermined ending condition is, for example, a condition based on at least one of Conditions (1) to (5):
(1) Condition in which the subject 200 overlaps at an end position 202 set in the imaging range 300;
(2) Condition in which the subject 200 is not detected from the imaging range 300;
(3) Condition in which a predetermined number of images are captured;
(4) Condition in which a predetermined time elapses; and
(5) Condition in which the subject 200 adopts a predetermined motion or orientation.

In Condition (2), the end timing of tracking of the subject 200 and the end timing of imaging of the subject 200 are the same timings. On the other hand, in Conditions (1), (3), (4), and (5), when tracking of the subject 200 is being performed and Conditions (1), (3), (4), and (5) are satisfied, imaging of the subject 200 may end. That is, by setting the ending condition in which tracking of the subject 200 ends such that tracking of the subject 200 ends after imaging of the subject 200 has ended, the end timing of tracking of the subject 200 may be later than the end timing of imaging of the subject 200. As a result, when imaging is started again at a predetermined timing between the end timing of imaging and the end timing of tracking, it is possible to rapidly start imaging of the subject 200.

All of Conditions (1) to (5) may be used as ending conditions, or which thereof is to be set as an ending condition may be arbitrarily changed by a user's selection. The predetermined number of images in Condition (3) or the predetermined time in Condition (4) may be set to a fixed value in advance or may be changed by a user's designation.

In Condition (1), the end positions 202 of tracking and imaging may be set to the same position or different positions. In Condition (5), for example, in the vaulting horse, a timing at which the subject 200 ends performance and an orientation in which the subject 200 overlapping the end position 202 raises both hands (for example, the subject 200 in FIG. 3F) is detected may be set to an imaging ending condition, and tracking may be set to end at a timing at which an orientation in which the subject lowers both hands is detected.

As in Condition (1), when the predetermined ending condition is set to a condition in which the subject 200 overlaps the end position 202, the position setting unit 401 sets the end position 202. Setting of the end position 202 can be performed on the basis of at least one of the focus information of the subject 200 and the predetermined area in the imaging range 300 similarly to setting of the tracking start position 201. Specifically, in setting the end position 202, a user disposes a person or an object at a position at which tracking or imaging ends (for example, a position of 10 m in front). The imaging device 1 focuses on and images the person or the object in the position setting mode. Accordingly, the position setting unit 401 sets the focus information at the end position 202.

The position setting unit 401 sets a predetermined area designated by a user in the imaging range 300 at the end position 202. In this embodiment, the end position 202 is set to be closer to the imaging device 1 than a landing point. The predetermined area indicating the end position 202 is an area at the screen center in the imaging range 300 and is, for example, a lower-left area (an area indicating a front side) of the imaging point image 302 in FIG. 3F.

The method of setting the focus information at the positions 201 to 203 is not limited to the method of disposing a person or an object at the positions 201 to 203 and focusing on the person or the object. For example, in the position setting mode, the focus information at the positions 201 to 203 may be able to be set by focusing on an athlete in practice. In addition, in the position setting mode, several images of the athlete in practice may be captured, one thereof may be selected by a user, and the focus information at the positions 201 to 203 acquired from the selected imaging result may be able to be set. The focus information may be set using a target that is present at a position at which tracking or imaging is started or ends. For example, when the focus information is manually set, a focus may be put on the target, and the focus information at that time may be stored in the ROM 13 or the RAM 14.

The tracking control unit 402 returns the position at which tracking is started to the tracking start position 201 when a predetermined ending condition is satisfied. Accordingly, it is possible to prepare for tracking of a next athlete.

### (Display of Object on Display Unit 16)

The display control unit 404 displays at least one of a first object indicating a tracking position by the tracking control unit 402 and a second object indicating imaging by the imaging control unit 403 to overlap an image of a subject 200. The first object is, for example, the tracking point image 301 (see FIGS. 3A to 3C). The second object is, for example, the imaging point image 302 (see FIG. 3D). Both the first object and the second object are not limited to images surrounding a focus point with a rectangle, but may be, for example, images surrounding the focus point with a circle or may be images of an arrow (a pointer), a line, or a point indicating the focus point.

The first object indicating tracking or the second object indicating imaging may not be displayed. The display control unit 404 may display the first position indicating a position at which tracking is started as a third object. The third object is illustrated as, for example, double rectangular frame (see FIG. 3A) but is not limited to this embodiment. When a subject 200 overlaps the first position and tracking of the subject 200 is started, the third object may be erased and the first object may be displayed, or the third object may be left without any change.

The display control unit 404 displays the first object, the second object, and the third object in different display modes. Specifically, the display control unit 404 displays the tracking start position image 210, the tracking point image 301, and the imaging point image 302 in different line types (display modes). The present invention is not limited thereto, and the display control unit 404 may display the tracking start position image 210, the tracking point image 301, and the imaging point image 302 in different colors or different shapes.

### (Setting Process of Setting Positions)

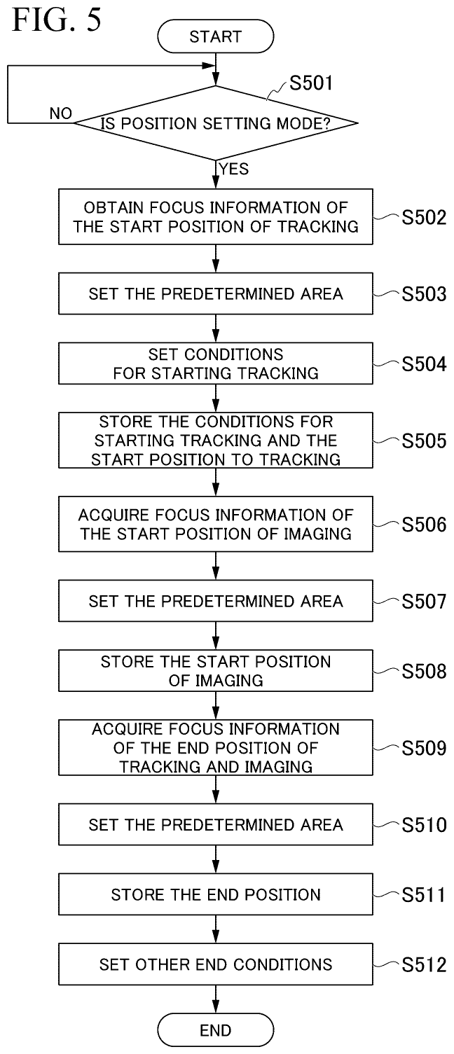

FIG. 5 is a flowchart illustrating an example of a position setting process that is performed by the imaging device 1. In FIG. 5, the imaging device 1 determines whether a position setting mode in which the positions (the tracking start position 201, the end position 202, and the imaging start position 203) are set has been performed (Step S501). When the imaging device 1 waits until the position setting mode is set (Step S501: NO) and the position setting mode is set (Step S501: YES), the imaging device 1 acquires focus information of the tracking start position (for example, a position of 40 m in front in the depth direction) (Step S502).

Then, the imaging device 1 sets a predetermined area in the imaging range 300 (for example, the imaging range of 40 m in front) by receiving the predetermined area from a user (Step S503). Then, the imaging device 1 sets a tracking starting condition (at least one of a face, a size, a motion, and orientation of the subject 200) in advance by receiving the tracking starting condition from the user (Step S504). Then, the imaging device 1 stores the tracking starting condition in the RAM 14 and stores the predetermined area in the imaging range 300 of 40 m in front as the tracking start position in the RAM 14 (Step S505).

Then, the imaging device 1 acquires focus information of a position at which imaging is started (for example, a position of 20 m in front in the depth direction) (Step S506). Then, the imaging device 1 sets a predetermined area in the imaging range 300 (an imaging range at a position of 20 m in front) by receiving the predetermined area from a user (Step S507). Then, the imaging device 1 stores the predetermined area in the imaging range 300 at a position of 20 m in front as an imaging start position in the RAM 14 (Step S508).

Then, the imaging device 1 acquires focus information of a position at which tracking and imaging end (for example, a position of 10 m in front in the depth direction) (Step S509). Then, the imaging device 1 sets a predetermined area in the imaging range 300 (for example, the imaging range at a position of 10 m in front) by receiving the predetermined area from the user (Step S510). Then, the imaging device 1 stores the predetermined area in the imaging range 300 of the position of 10 m in front as an end position in the RAM 14 (Step S511).

Then, the imaging device 1 sets other ending conditions (Step S512) and ends this series of processes. For example, setting of other ending conditions includes setting of a predetermined number of captured images, setting of a predetermined time in which imaging is performed, or setting of whether the ending conditions include a condition in which the subject 200 is not detected from the imaging range 300.

Through the aforementioned flowchart, setting of the positions (the tracking start position 201, the end position 202, and the imaging start position 203) ends.

(Processes Associated with Tracking and Imaging)

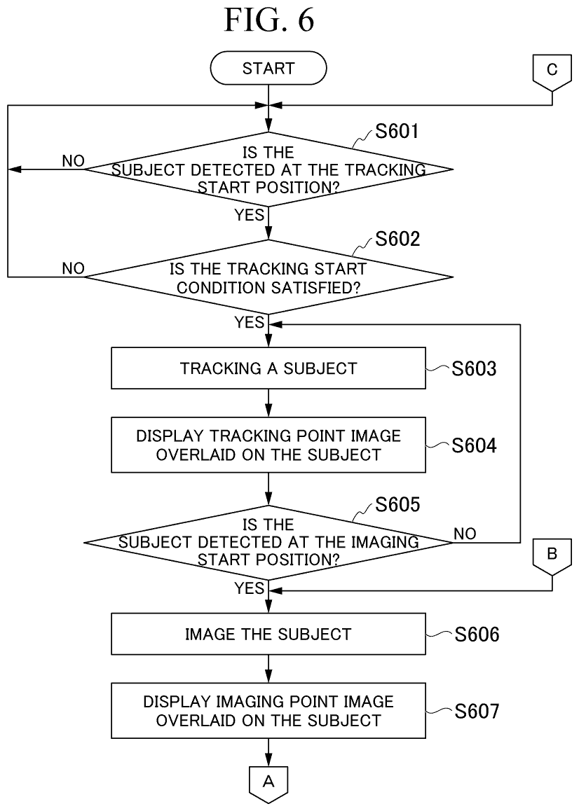

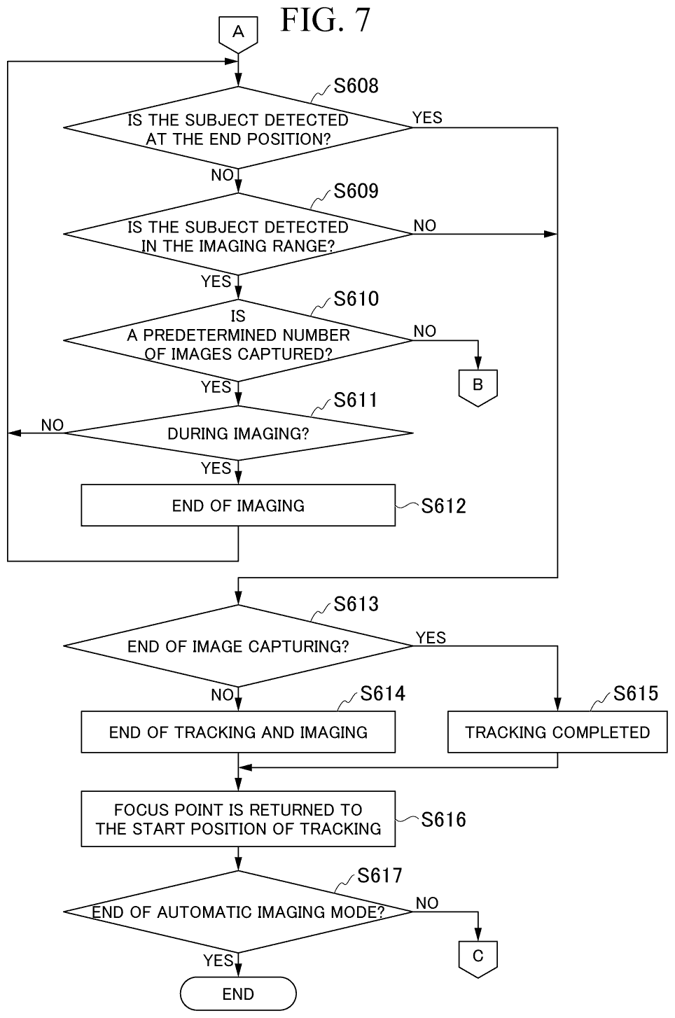

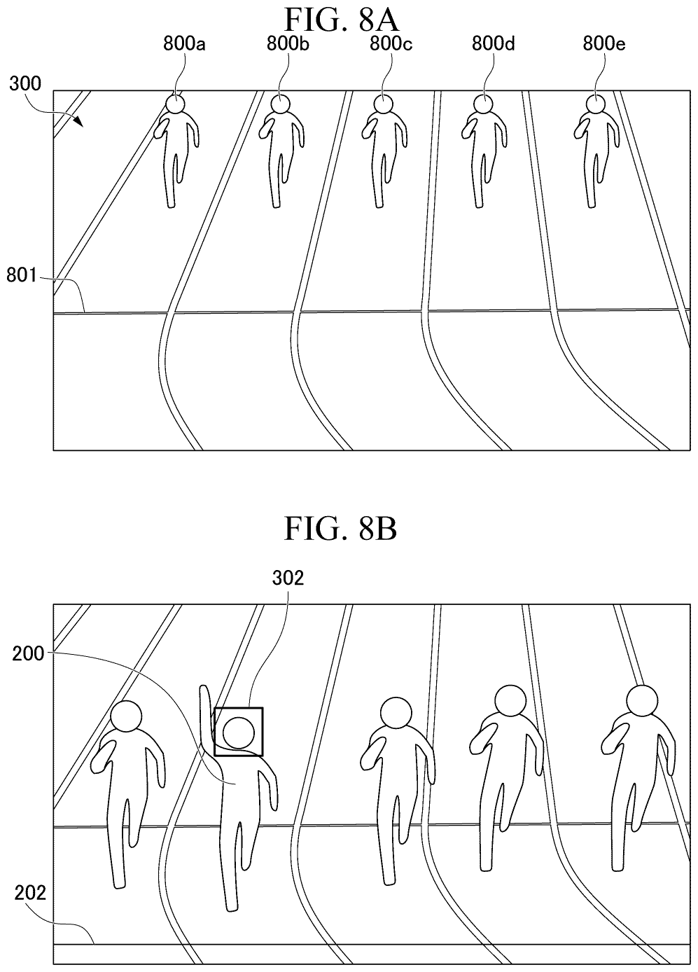

FIGS. 6 and 7 are flowcharts illustrating an example of the tracking and imaging processes according to the first embodiment. In FIGS. 6 and 7, the imaging device 1 is set to an automatic imaging mode in which tracking and imaging according to the first embodiment are performed.

In FIGS. 6 and 7, the imaging device 1 determines whether a subject 200 has been detected at the tracking start position 201 (Step S601). The imaging device 1 waits until a subject 200 is detected as the tracking start position 201 (Step S601: NO) and determines whether a tracking start condition has been satisfied (Step S602) when a subject 200 is detected at the tracking start position 201 (Step S601: YES). The tracking start condition includes, for example, at least one of a condition in which the subject 200 is a face of a person, a condition in which the subject 200 has a predetermined size, a condition in which the subject 200 adopts a predetermined motion, and a condition in which the subject 200 adopts a predetermined orientation.

When the tracking start condition has not been satisfied (Step S602: NO), that is, for example, when a person other than an athlete to be tracked such as an umpire adopting a motion other than that of an athlete is detected in the imaging range 300, the imaging device 1 does not perform tracking and performs Step S601 again. On the other hand, when the tracking start condition has been satisfied (Step S602: YES), that is, when a person (athlete) to be tracked is detected, the imaging device 1 performs tracking of the subject 200 (Step S603). When tracking of the subject 200 is started, the imaging device 1 displays the tracking point image 301 (see FIGS. 3A to 3C) on the display unit 16 to overlap the subject 200 (Step S604).

Then, the imaging device 1 determines whether the subject 200 has been detected at the imaging start position 203 (Step S605). When the subject 200 has not been detected at the imaging start position 203 (Step S605: NO), the imaging device 1 continues to perform tracking of the subject 200 and displaying of the subject 200 and the tracking point image 301 in Step S603.

On the other hand, when the subject 200 has been detected at the imaging start position 203 (Step S605: YES), the imaging device 1 images the subject 200 (Step S606). When imaging of the subject 200 is started, the imaging device 1 displays the imaging point image 302 (see FIG. 3D) on the display unit 16 to overlap the subject 200 (Step S607).

Then, the imaging device 1 determines whether the subject 200 has been detected at the end position 202 (Step S608). When the subject 200 has not been detected at the end position 202 (Step S608: NO), the imaging device 1 determines whether the subject 200 is detected in the imaging range 300 (Step S609).

When the subject 200 is detected in the imaging range 300 (Step S609: YES), the imaging device 1 determines whether a predetermined number of images have been captured (Step S610). In Step S610, it may be determined whether a predetermined time has elapsed.

When the predetermined number of images have not been captured (Step S610: NO), the imaging device 1 continues to perform imaging of the subject 200 and displaying of the subject 200 and the imaging point image 302 in Step S606. On the other hand, when the predetermined number of images have been captured (Step S610: YES), the imaging device 1 determines whether imaging is being performed (Step S611). When imaging is being performed (Step S611: YES), the imaging device 1 end the imaging (Step S612) and performs Step S608 again. When it is determined in Step S611 that imaging is not being performed (Step S611: NO), the imaging device 1 performs Step S608 again.

When it is determined in Step S608 that the subject has been detected at the end position 202 (Step S608: YES) or when it is determined in Step S609 that the subject 200 is not being detected in the imaging range 300 (Step S609: NO), the imaging device 1 determines whether imaging has ended (Step S613). When imaging has not ended (Step S613: NO), the imaging device 1 ends tracking and imaging (Step S614) and performs Step S616. When imaging has ended (Step S613: YES), the imaging device 1 ends tracking (Step S615).

Then, the imaging device 1 returns the focus point to the tracking start position 201 (Step S616). Accordingly, the imaging device 1 prepares for tracking a next race. Then, the imaging device 1 determines whether the automatic imaging mode is to end (Step S617). When the automatic imaging mode is not to end (Step S617: NO), the imaging device 1 performs Step S601 again. On the other hand, when the automatic imaging mode is to end (Step S617: YES), the imaging device 1 ends this series of processes.

As described above, the imaging device 1 according to the first embodiment sets a tracking start position 201 in an imaging range 300 in which a subject 200 is imaged and tracks the subject 200 on the basis of a result of detection of the subject 200 overlapping the tracking start position 201. Accordingly, even when a plurality of subjects are present in the imaging range 300, a subject not overlapping the tracking start position 201 can be made not to be tracked. That is, it is possible to track only a subject 200 overlapping the tracking start position 201. Accordingly, according to this embodiment, it is possible to track and image a subject 200 desired by a user.

In the first embodiment, the result of detection of a subject 200 includes at least one of a face, a size, a motion, and a orientation of the subject 200. Accordingly, it is possible to accurately detect an athlete who is a subject 200 to be tracked. As a result, it is possible to accurately track and image a subject 200 desired by a user.

In the first embodiment, the tracking start position 201 is set on the basis of focus information of a subject 200 and/or a predetermined area in an imaging range 300. Accordingly, an athlete in focus and/or an athlete detected in the predetermined area can be tracked as a subject 200. As a result, it is possible to accurately track and image a subject 200 desired by a user.

In the first embodiment, tracking of a subject 200 includes tracking of focusing on the subject 200 and maintaining the in-focus state. Accordingly, it is possible to put a focus on the subject 200 and to track the subject 200. As a result, it is possible to image the subject 200 at a timing desired by a user.

In the first embodiment, the imaging device 1 sets an imaging start position 203 and starts imaging of a subject 200 overlapping the imaging start position 203 after having started tracking of the subject 200. Accordingly, even when a plurality of subjects are present in the imaging range 300, a subject not overlapping the tracking start position 201 and the imaging start position 203 can be made not to be imaged. That is, it is possible to image only a subject 200 overlapping the tracking start position 201 and the imaging start position 203. Accordingly, it is possible to image a subject 200 desired by a user. Since imaging is not performed before a subject 200 overlaps the imaging start position 203, it is possible to curb storing of unnecessary image data.

In the first embodiment, the tracking start position 201 and the imaging start position 203 are set to positions separated from each other in the depth direction of the imaging range 300. Accordingly, it is possible to efficiently track and image a subject 200 moving in an advancing or retracting direction of the imaging device 1. Accordingly, by disposing the imaging device 1 at a position at which a moving direction of an athlete in various sports events is the advancing or retracting direction, it is possible to perform desired imaging of the athlete who is a subject 200.

In the first embodiment, the imaging device 1 ends tracking of a subject 200 and imaging of the subject 200 when a predetermined ending condition has been satisfied. Accordingly, it is possible to end tracking and imaging of an athlete (a subject 200) having finished a sports event. It is possible to curb storing unnecessary image data in the storage medium 19 after the corresponding sports event has ended.

In the first embodiment, the ending condition in which tracking of a subject 200 ends is set such that tracking of the subject 200 ends after imaging of the subject 200 has ended. Accordingly, since tracking is performed until imaging ends, it is possible to acquire excellent image data. That is, it is possible to curb storing of unnecessary data in the storage medium 19. When imaging is performed again while tracking of a subject 200 is being performed after imaging has ended, it is possible to rapidly image the subject 200 which is being tracked.

In the first embodiment, the predetermined ending condition includes at least one of a condition in which a predetermined number of images have been captured, a condition in which a subject 200 overlaps the end position set in the imaging range 300, a condition in which the subject 200 is not detected in the imaging range 300, a condition in which a predetermined time elapses, and a condition in which the subject 200 adopts a predetermined motion or orientation. Accordingly, it is possible to efficiently curb storing of unnecessary image data in the storage medium 19.

In the first embodiment, the imaging device 1 returns a position at which tracking is started to the tracking start position 201 when the predetermined ending condition has been satisfied. Accordingly, it is possible to prepare for tracking a next subject 200 (an athlete) in various sports events.

In the first embodiment, the imaging device 1 displays at least one of the tracking point images 301 indicating a tracking position and the imaging point image 302 indicating imaging to overlap an image of a subject 200. Accordingly, it is possible to allow a user to recognize that tracking of the subject 200 is being performed or imaging of the subject 200 is being performed. As a result, the user can visually ascertain whether the subject 200 to be tracked or imaged is a desired subject 200.

In the first embodiment, the imaging device 1 displays the tracking point image 301 and the imaging point image 302 in different display modes. Accordingly, it is possible to allow a user to recognize which of tracking of a subject 200 and imaging of the subject 200 is being performed. As a result, the user can visually ascertain whether the subject 200 which is being tracked is a desired subject 200 or whether the subject 200 which is being imaged is the desired subject 200.

The imaging device 1 according to the first embodiment images, for example, an athlete in a vaulting competition of a gymnastics event but is not limited thereto. The imaging device 1 according to the first embodiment can image an athlete in a gymnastics event other than the vaulting competition and can also image an athlete in a track and field event such as long jump, triple jump, high jump, or pole jump.

### Modified Examples of First Embodiment and Other Embodiments

Modified examples of the first embodiment and other embodiments will be described below. In the modified examples and other embodiments described below, description of the same as described above in the first embodiment will be appropriately omitted. In the following modified examples, the following other embodiments, and the first embodiment can also be combined.

### Modified Example 1

Modified Example 1 of the first embodiment will be first described below. In the first embodiment, the tracking start position 201 is based on the focus information of a subject 200. In Modified Example 1, in addition to or instead of the aforementioned configuration of the first embodiment, a configuration for setting the tracking start position 201 based on distance information in the depth direction of the imaging range 300 will be described.

In Modified Example 1, the tracking start position 201 is based on distance information in the depth direction of the imaging range 300 and a predetermined area in the imaging range 300. The distance information is, for example, information indicating a distance (for example, 40 m) in the depth direction from the imaging device 1. For example, the distance can be measured using a time-of-flight method. The position setting unit 401 sets the tracking start position 201 by receiving the distance (40 m) indicating the tracking start position 201 from a user via the operation unit 18 or the display unit 16 in the position setting mode. For example, the position setting unit 401 sets the predetermined area in the imaging range 300 in accordance with the user's operation. As a result, the predetermined area in the imaging range 300 indicating the set distance (a position of 40 m in front) is set as the tracking start position 201.

When the tracking start position 201 is set on the basis of the distance information in the depth direction of the imaging range 300 in the imaging range 300, tracking is started with overlapping of a subject 200 on the set distance (for example, 40 m) (passing through a position of 40 m in front). This case includes a case in which the subject 200 partially overlaps the set distance as well as a case in which the subject 200 fully overlaps the set distance. Tracking may be started when the subject 200 passes through the set distance or tracking may be started after the subject 200 has passed through the set distance.

In Modified Example 1, the end position 202 or the imaging start position 203 can also be set on the basis of the distance information in the depth direction of the imaging range 300 and the predetermined area in the imaging range 300. The distance information of the end position 202 or the imaging start position 203 is, for example, information indicating a distance (for example, 10 m for the end position 202 or 20 m for the imaging start position 203) in the depth direction from the imaging device 1. The position setting unit 401 sets the end position 202 or the imaging start position 203 by receiving the distance (10 m or 20 m) indicating the end position 202 or the imaging start position 203 from a user via the operation unit 18 or the display unit 16 in the position setting mode. For example, the position setting unit 401 sets the predetermined area in the imaging range 300 in accordance with the user's operation.

The positions 201 to 203 may be set on the basis of at least one of the distance pieces of information in the depth direction of the imaging range 300 and the predetermined area in the imaging range 300. That is, the positions 201 to 203 may be set on the basis of only the distance information in the depth direction of the imaging range 300 or may be set on the basis of only the predetermined area in the imaging range 300.

As described above, in Modified Example 1, the tracking start position 201 is set on the basis of the distance information in the depth direction of the imaging range 300 and/or the predetermined area in the imaging range 300. Accordingly, it is possible to track an athlete located at a distance indicated by the distance information and/or an athlete detected in the predetermined area as a subject 200. As a result, it is possible to accurately track and image a subject 200 desired by a user.

### Modified Example 2

Modified Example 2 of the first embodiment will be described below. In Modified Example 2, a configuration in which tracking and imaging are controlled in different control manners after tracking of a subject 200 and imaging of the subject 200 have been started will be described.

In Modified Example 2, a viewing angle (a zoom) may be changeable after tracking of a subject has been started. For example, the viewing angle can be changed such that the area of the subject is constant in the imaging range 300. The area of a subject is, for example, an area of the whole body of an athlete. The imaging device 1 decreases the viewing angle (zooms in) for a subject 200 at a start spot and increases the viewing angle as the subject 200 becomes closer to the imaging device 1. Accordingly, it is possible to acquire an excellent captured image including the athlete (the subject 200) as a main.

In Modified Example 2, a shutter speed (a frame imaging interval) may be changeable after imaging has been started. For example, the shutter speed while an athlete is moving from a takeoff board to a landing mat may be set to be higher than the shutter speed while the athlete moves through another position. Accordingly, a most important scene or a scene in which the subject 200 in a series of vaulting competitions moves fast can be more imaged.

### Second Embodiment

A second embodiment will be described below. In the first embodiment, an athlete of a vaulting competition in the gymnastics event is tracked and imaged as a subject 200. In the second embodiment, it is assumed that an athlete having first passed through a finish line in the track and field event is tracked and imaged as a subject 200.

FIG. 8A is a diagram illustrating an example of an image in an imaging range 300 of an imaging device 1 according to the second embodiment and illustrates an image before a subject reaches a tracking/imaging start position. FIG. 8B is a diagram illustrating an example of an image in the imaging range 300 of the imaging device 1 according to the second embodiment and illustrates an image when the subject having reached the tracking/imaging start position is imaged. In FIG. 8A, a tracking/imaging start position 801 is set at a finish line in the imaging range 300. The tracking/imaging start position 801 is a tracking start position at which tracking of focusing on a specific subject 200 and maintaining the in-focus state is performed. The tracking/imaging start position 801 is a tracking start position and is also an imaging start position at which imaging is started.

FIG. 8A illustrates an image before a subject reaches the finish line. Before a subject reaches the finish line (the tracking/imaging start position 801), the tracking control unit 402 detects candidates 800 (a plurality of subjects) for tracking of focusing on a subject and maintaining the in-focus state when a subject overlaps the finish line. Specifically, before a subject reaches the finish line, the tracking control unit 402 does not put a focus but detects a plurality of athletes which are candidates 800 (800a to 800e) for a subject 200 to be tracked in a horizontal line. Accordingly, a focus is not set before the subject reaches the finish line.

A position at which detecting of a horizontal line is started can be set to an arbitrary position by a user. For example, the position at which detecting of a horizontal line is started may be set to a start line or may be set to an arbitrary position between the start line and the finish line. When the candidates 800 are detected at the position at which detecting of a horizontal line is started, the imaging control unit 403 starts detecting of the candidates 800 in a horizontal line.

The tracking control unit 402 tracks a subject 200 first overlapping the tracking/imaging start position 801 on the basis of the result of detection of the candidates 800 overlapping the tracking/imaging start position 801. Specifically, the tracking control unit 402 identifies and tracks the subject 200 on which tracking of focusing on and tracking the head athlete having first reached the finish line is performed. In this identification, for example, a result of image processing such as computer vision based on the result of detection of subjects in the horizontal line is used. Accordingly, a subject 200 to be tracked is identified out of a plurality of candidates 800 (a plurality of athletes).

FIG. 8B illustrates an image when an athlete having first reached the finish line is focused and tracked as a subject 200 and the subject 200 is imaged. As illustrated in FIG. 8B, the imaging control unit 403 images an athlete having first reached the finish line (the tracking/imaging start position 801). The display control unit 404 displays the imaging point image 302 on the display unit 16 to overlap the subject 200.

When a predetermined ending condition such as a condition in which the subject 200 reaches the end position 202 is satisfied, tracking and imaging of the subject 200 end. In this embodiment, the tracking start position and the imaging start position are set to the finish line together. The tracking start position may be set before the finish line and the imaging start position may be set to the finish line.

(Processes Associated with Tracking and Imaging According to Second Embodiment)

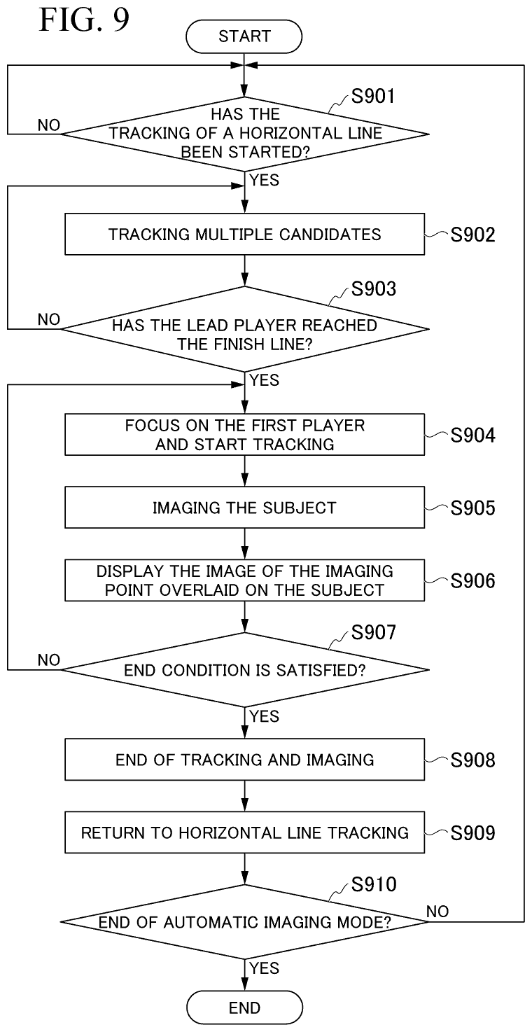

FIG. 9 is a flowchart illustrating an example of a tracking and imaging process according to the second embodiment. In FIG. 9, it is assumed that the imaging device 1 is set to an automatic imaging mode in which tracking and imaging according to the second embodiment is performed. In FIG. 9, predetermined ending conditions for ending tracking and imaging with a focus will be simply described.

In FIG. 9, the imaging device 1 determines whether tracking in a horizontal line has been started (Step S901). The imaging device 1 waits until tracking in a horizontal line is started (Step S901: NO) and performs tracking of a plurality of candidates 800 in a horizontal line (Step S902) when tracking in the horizontal line is started (Step S901: YES). Then, the imaging device 1 determines whether the head candidate out of the candidates 800 has reached the tracking/imaging start position 801 (the finish line) (Step S903). When the head candidate has not reached the tracking/imaging start position 801 (Step S903: NO), the imaging device 1 performs Step S902 again and continues to track the candidates 800 in the horizontal line.

When the head candidate has reached the tracking/imaging start position 801 (Step S903: YES), the imaging device 1 performs tracking of the head candidate 800 as a subject 200 to be focused on and tracked (Step S904). Then, the imaging device 1 images the subject (Step S905). When imaging of the subject 200 is started, the imaging device 1 displays the imaging point image 302 (see FIG. 8B) on the display unit 16 to overlap the subject 200 (Step S906).

Then, the imaging device 1 determines whether a predetermined ending condition has been satisfied (Step S907). When a predetermined ending condition has not been satisfied (Step S907: NO), the imaging device 1 performs Step S907 again and continues to perform tracking and imaging of the subject 200 and displaying of the subject 200 and the imaging point image 302. On the other hand, when the predetermined ending condition has been satisfied (Step S907: YES), the imaging device 1 ends tracking and imaging of the subject 200 (Step S908) and returns to settings in which tracking in the horizontal line is performed (Step S909).

Then, the imaging device 1 determines whether the automatic imaging mode has ended (Step S910). When the automatic imaging mode has not ended (Step S910: NO), the imaging device 1 performs Step S901 again. On the other hand, when the automatic imaging mode has ended (Step S910: YES), the imaging device 1 ends this series of processes.

As described above, the imaging device 1 according to the second embodiment tracks candidates 800 (a plurality of subjects) for tracking of focusing on a subject 200 and maintaining the in-focus state before the subject 200 overlaps the tracking/imaging start position 801. Accordingly, even when a head candidate 800 out of the plurality of candidates 800 (athletes) is not determined in advance as in a track and field event, it is possible to track and image a candidate 800 first overlapping the tracking/imaging start position 801 as the subject 200 to be tracked. As a result, it is possible to track and image a subject 200 desired by a user.

### Third Embodiment

A third embodiment will be described below. In the third embodiment, a configuration in which a position received from a user via a screen of the display unit 16 is set as a tracking start position 201 will be described. In the third embodiment, it is assumed that the tracking start position 201 is set to a slalom gate part in a skiing event.

In the third embodiment, the position setting unit 401 sets a position received from a user as a tracking start position 201. This operation of receiving a position from a user includes an operation of touching the display unit 16 or an operation of operating a button of the operation unit 18. Specifically, the display unit 16 displays a result of imaging of a subject. In the third embodiment, the imaging device 1 includes an input unit. The input unit receives a user's input when the user touches the display unit 16. The position setting unit 401 sets an area received from the user by the input unit as a tracking start position 201. The position setting unit 401 can also set a position received from the user as a prohibition position at which a subject is not tracked.

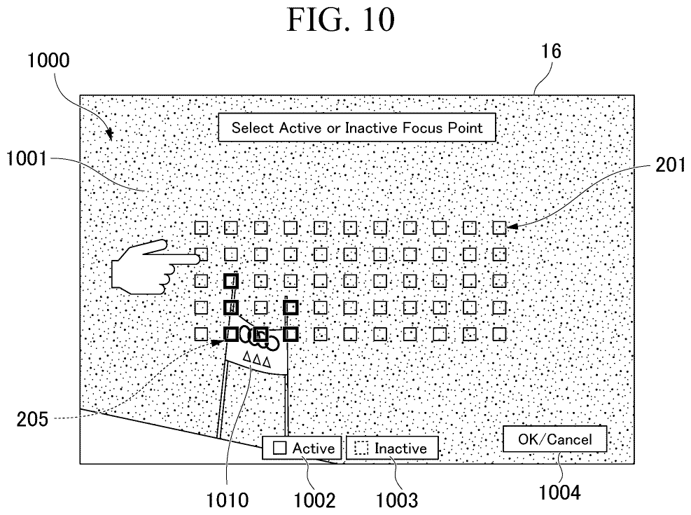

FIG. 10 is a diagram illustrating an example of a screen when the imaging device 1 according to the third embodiment receives settings of positions from a user. In FIG. 10, a reception screen 1000 is displayed on the display unit 16. In the reception screen 1000, an imaging result 1001, a tracking start position selection button 1002, a prohibition position selection button 1003, an ascertainment button 1004, a tracking start position 201, and a prohibition position 205 are displayed.

When a user touches the tracking start position selection button 1002 and touches an arbitrary position on the screen, the touched position is displayed as the tracking start position 201. In the drawing, the tracking start position 201 is set to a position through which an athlete (a subject 200 to be tracked) passes in the vicinity of a slalom gate 1010. When the user touches the prohibition position selection button 1003 and touches an arbitrary position on the screen, the touched position is displayed as the prohibition position 205. In the drawing, the prohibition position 205 is set to a part of the slalom gate 1010. That is, setting is performed such that the slalom gate 1010 is not tracked. The ascertainment button 1004 receives determination or cancellation of the tracking start position 201 and the prohibition position 205 received from the user.

In FIG. 10, the tracking start position 201 and the prohibition position 205 are distinguished from each other by displaying the positions in different colors, but the present invention is not limited thereto. For example, when the user selects the prohibition position 205, display of the corresponding area may be deleted. In this case, by pushing an initialization button (not illustrated) to display the deleted area again, the user can perform the setting again. The tracking start position 201 and the prohibition position 205 may be set, for example, using a cross key (not illustrated) instead of the user's touching the screen. In this case, setting may be performed such that an area set as the tracking start position 201 in advance is switched to the prohibition position 205 when the area is selected using the cross key and an area set as the prohibition position 205 is switched to the tracking start position 201 when the area is selected using the cross key.

When the tracking start position 201 and the prohibition position 205 are set by allowing a user to touch the screen, the user may be notified that the positions are touched and desired settings are determined by causing the screen to vibrate, emitting confirmation sound, or the like. The imaging device 1 may automatically recognize the slalom gate 1010 and automatically set the slalom gate 1010 as the prohibition position 205. In this case, the user can finely correct the prohibition position 205 by touching areas in the vicinity of the slalom gate 1010. When the tracking start position 201 includes a plurality of positions in the imaging range, tracking may be started when the subject 200 overlaps one tracking start position 201, or tracking may be started when the subject 200 overlaps all the tracking start positions 201. The imaging device 1 may detect a subject 200 passing through the tracking start positions 201 and start tracking when the subject 200 passes through the tracking start positions 201.

### (Process of Setting Tracking Start Position According to Third Embodiment)

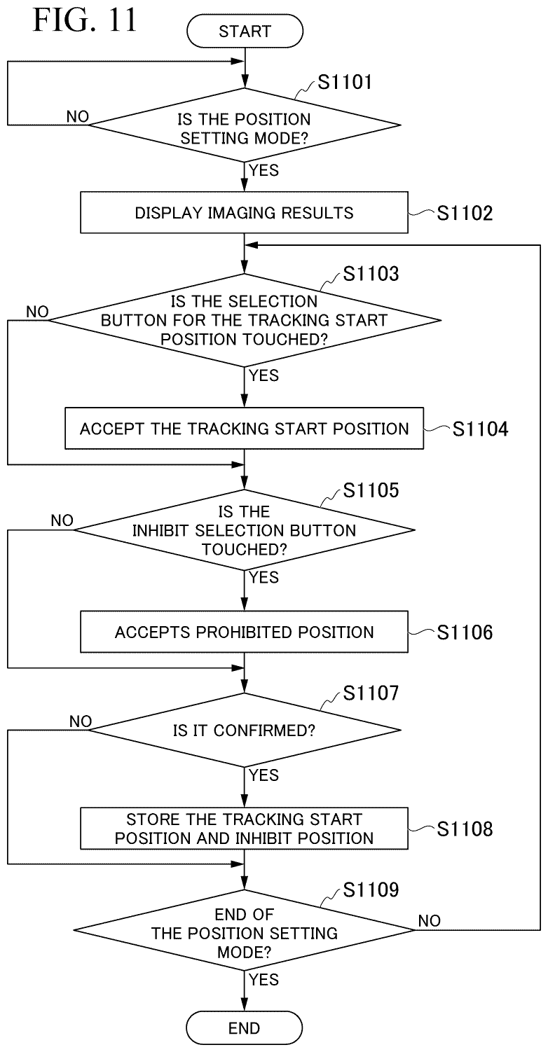

FIG. 11 is a flowchart illustrating an example of a process of setting a tracking start position according to the third embodiment. In FIG. 11, the imaging device 1 determines whether a position setting mode in which setting of positions is performed has been set (Step S1101). The imaging device 1 waits until the position setting mode is set (Step S1101: NO) and displays a result of imaging on the display unit 16 (Step S1102) when the position setting mode is set (Step S1101: YES).

Then, the imaging device 1 determines whether the tracking start position selection button 1002 (see FIG. 10) has been touched (Step S1103). When the tracking start position selection button 1002 has not been touched (Step S1103: NO), the imaging device 1 performs Step S1105. When the tracking start position selection button 1002 has been touched (Step S1103: YES), the imaging device 1 receives an arbitrary position on the screen as the tracking start position 201 (Step S1104).

Then, the imaging device 1 determines whether the prohibition position selection button 1003 (see FIG. 10) has been touched (Step S1105). When the prohibition position selection button 1003 has not been touched (Step S1105: NO), the imaging device 1 performs Step S1107. When the prohibition position selection button 1003 has been touched (Step S1105: YES), the imaging device 1 receives an arbitrary position on the screen as the prohibition position 205 (Step S1104).

Then, the imaging device 1 determines whether the tracking start position 201 and the prohibition position 205 have been confirmed by touching the ascertainment button 1004 (see FIG. 10) (Step S1107). When the tracking start position 201 and the prohibition position 205 have not been confirmed (Step S1107: NO), the imaging device 1 performs Step S1109. When the tracking start position 201 and the prohibition position 205 have been confirmed (Step S1107: YES), the imaging device 1 stores the tracking start position 201 and the prohibition position 205 received from the user in the RAM 14 (Step S1108).

Then, the imaging device 1 determines whether the position setting mode is to end (Step S1109). When the position setting mode is not to end (Step S1109: NO), the imaging device 1 performs Step S1103 again. When the position setting mode is to end (Step S1109: YES), the imaging device 1 this series of processes.

In the third embodiment, the imaging start position may be set to the same as the tracking start position 201. That is, settings of the imaging start position may be received as the same time as receiving the tracking start position 201 on the reception screen 1000 (see FIG. 10). The imaging start position may be set to a position different from the tracking start position 201. In this case, separately from settings of the tracking start position 201, settings of the imaging start position may be received from the screen of the display unit 16.

In the third embodiment, the ending condition includes, for example, a condition in which a subject 200 is not detected in the imaging range 300, a condition in which a predetermined number of images are captured, or a condition in which a predetermined time elapses. Here, the ending condition may be set to a condition in which a subject 200 overlaps an end position set in the imaging range 300. In this case, setting of the end position may be performed on the screen of the display unit 16 similarly to setting of the tracking start position 201.

As described above, the imaging device 1 according to the third embodiment sets a position received from a user as the tracking start position 201. Accordingly, the user can easily set the tracking start position 201.

The imaging device 1 according to the third embodiment sets a position received from a user as the prohibition position 205 at which a subject is not tracked. Accordingly, it is possible to curb tracking of an object other than a desired subject 200 as a subject 200.

The imaging device 1 according to the third embodiment receives a user's input and sets the received area as the tracking start position 201 when a user touches the display unit 16 on which a result of imaging of a subject is displayed. Accordingly, the user can more easily set the tracking start position 201 using the display unit 16.

While some embodiments of the present invention have been described above, the embodiments are presented as an example and are not intended to limit the scope of the present invention. The embodiments can be modified in various forms and can be subjected to various omissions, substitutions, and alterations without departing from the gist of the present invention. The embodiments or modifications thereof are included in the scope or gist of the present invention and re included in the inventions described in the appended claims and the scopes equivalent thereto.

A program for realizing the control unit 15 and the imaging device 1 which have been described above may be recorded on a computer-readable storage medium, and a computer system may be caused to read and execute the program. The “computer system” mentioned herein includes an OS or hardware such as peripherals. The “computer-readable storage medium” means a portable medium such as a flexible disk, a magneto-optical disc, a ROM, or a CD-ROM or a storage device such as a hard disk incorporated into the computer system. The “computer-readable storage medium” includes a medium that holds a program for a predetermined time such as a volatile memory (RAM) in a computer system serving as a server or a client when the program is transmitted via a network such as the Internet or a communication line such as a telephone line. The program may be transmitted from the computer system storing the program in a storage device or the like to another computer system via a transmission medium or a carrier wave in the transmission medium. Here, the “transmission medium” for transmitting the program is a medium having a function of transmitting information such as a network (a communication network) such as the Internet or a communication circuit (a communication line) such as a telephone line. The program may be for realizing some of the aforementioned functions. The program may be a program for realizing the aforementioned functions in combination with a program recorded in advance in the computer system, that is, a differential program (a differential file).

### REFERENCE SIGNS LIST

1 Imaging device
12 Image processing unit
15 Control unit
16 Display unit
201 Tracking start position
202 Ending position
203 Imaging start position
205 Prohibition position
210 Tracking start position image
300 Imaging range
301 Tracking point image
302 Imaging point image
401 Position setting unit
402 Tracking control unit
403 Imaging control unit
404 Display control unit
800 Candidate
801 Tracking/imaging start position
1001 Imaging result

1. An imaging control device comprising:
a position setting unit configured to set a first position indicating a position at which tracking of a subject starts in an imaging range in which the subject is imaged; and
a tracking control unit configured to track the subject on the basis of a result of detection of the subject overlapping the first position set by the position setting unit.

2. The imaging control device according to claim 1, wherein the result of detection of the subject includes at least one of a face, a size, a motion, and an orientation of the subject.

3. The imaging control device according to claim 1, wherein the first position is set on the basis of distance information in a depth direction of the imaging range and/or a predetermined imaging area in the imaging range.

4. The imaging control device according to claim 1, wherein the first position is set on the basis of focus information of the subject and/or a predetermined imaging area in the imaging range.

5. The imaging control device according to claim 1, wherein the tracking of the subject includes tracking of focusing on the subject and maintaining an in-focus state.

6. The imaging control device according to claim 1, wherein the tracking control unit returns the position at which tracking starts to the first position when a predetermined ending condition is satisfied.

7. The imaging control device according to claim 1, wherein the position setting unit sets a second position indicating a position at which imaging of the subject starts,
wherein the imaging control device further comprises an imaging control unit configured to start imaging of the subject overlapping the second position after tracking of the subject has started.

8. The imaging control device according to claim 7, wherein the first position and the second position are positions separated from each other in a depth direction of the imaging range.

9. The imaging control device according to claim 7, wherein the tracking control unit ends tracking of the subject when a predetermined ending condition is satisfied, and
wherein the imaging control unit ends imaging of the subject when the predetermined ending condition is satisfied.

10. The imaging control device according to claim 9, wherein the predetermined ending condition for ending tracking of the subject is set such that tracking of the subject ends after imaging of the subject has ended.

11. The imaging control device according to claim 10, wherein the predetermined ending condition is a condition based on at least one of a condition that a predetermined number of images are captured, a condition that the subject overlaps an end position set in the imaging range, a condition that the subject is not detected from the imaging range, a condition that the subject adopts a predetermined motion or orientation, and a condition that a predetermined elapses.

12. The imaging control device according to claim 7, further comprising a display control unit configured to display at least one of a first object indicating a tracking position of the tracking control unit and a second object indicating imaging by the imaging control unit to overlap an image of the subject.

13. The imaging control device according to claim 12, wherein the display control unit displays the first object and the second object in different display modes.

14. The imaging control device according to claim 5, wherein, when the tracking of focusing on the subject and maintaining the in-focus state is performed, the tracking control unit detects a subject which is a candidate on which the tracking of focusing on the subject and maintaining the in-focus state is to be performed after the subject overlaps the first position before the subject overlaps the first position.

15. The imaging control device according to claim 1, wherein the position setting unit sets a position received from a user as the first position.

16. The imaging control device according to claim 1, wherein the position setting unit sets a position received from a user as a prohibition position at which the subject is not tracked.

17. An imaging device comprising the imaging control device according to claim 1.

18. The imaging device according to claim 17, further comprising:
a display unit configured to display an imaging result of a subject; and
an input unit configured to receive an input from a user by allowing the user to touch the display unit,
wherein the position setting unit sets an area received from the user by the input unit as the first position.

19. A program causing a computer used in an imaging control device to serve as:
a position setting unit configured to set a first position indicating a position at which tracking of a subject starts in an imaging range in which the subject is imaged; and
a tracking control unit configured to track the subject on the basis of a result of detection of the subject overlapping the first position set by the position setting unit.
